(19) United States
(12) Patent Application Publication
(10) Pub. No.: US 2005/0024346 A1
(43) Pub. Date: Feb. 3, 2005

(54) Digital pen function control

(76) Inventors: Jean-Luc Dupraz, Echandens (CH); Florian M. Kehlstadt, Au Chalet (CH); Emmanuel Dubois, Sergy (FR); Fabrice Lauper, Lausanne (CH)

Correspondence Address: FENWICK & WEST LLP, SILICON VALLEY CENTER, 801 CALIFORNIA STREET, MOUNTAIN VIEW, CA, 94041, US

(21) Appl. No.: 10/631,434

(22) Filed: Jul. 30, 2003

(51) Int. Cl. G09G 5/00

(52) U.S. Cl. 345/179

(57) ABSTRACT

A digital writing system according to one embodiment of the present invention captures handwritten gestures in addition to text and patterns. It may include, among other things, a digital pen, special erasable ink and paper, and application software for the managing of captured files with a corresponding user interface. A digital pen according to one embodiment of the present invention may include character recognition subsystem, function control subsystem with selection mechanisms, a processor subsystem, memory subsystems, and wired or wireless communication subsystems. In addition, embodiments of a digital pen according to the present invention may include additional functional features including, for example, a user notification (e.g., alarm) feature, a digital camera feature, voice recording and recognition features, calendar features, calculator features, biometric sensor features, and the like.

### FIELD OF THE INVENTION

The present invention relates generally to digital writing input devices for computer systems and more particularly to a multi-function digital pen with function control features.

### BACKGROUND OF THE INVENTION

Conventional digital pen devices that capture handwriting strokes are known. One type of conventional prior art digital pen device includes a digital pen and tablet configuration. The digital pen and tablet couple together. The tablet couples with a personal computer. The tablet includes electronics to recognize character strokes when the digital pen is in contact with the tablet. In addition, the tablet may include special function areas on which a user may tap with the digital pen to invoke a function. The function may be pre-configured or pre-programmed. For example, the function can be preprogrammed to include a keystroke function such as open file, e.g., <CNTL><O>, or print file, e.g., <CNTL><P>.

The digital pen and tablet configuration includes a number of drawbacks. For example, the digital pen and tablet are bulky units. They require a large surface area for use and are too heavy to be considered portable. In addition, the pen is not useful without the tablet and vice versa. To help address these shortcomings, another conventional digital pen device has appeared on the market, the Anoto Digital Pen, which is manufactured by a subsidiary of C Technologies AB of Sweden, Anoto AB of Sweden.

The Anoto Digital Pen includes a digital camera, an advanced image-processing unit and a Bluetooth radio transceiver. It also contains an ink cartridge so a user can see what is written or drawn. The image capturing mechanism of the Anoto Digital Pen is activated by removing a cap and deactivated by replacing the cap again. However, the image processing capability of the Anoto Digital Pen is operational only when the Anoto Digital Pen is used with a specially designed paper. The specially designed paper must include a custom pattern that consists of very small dots slightly displaced from a grid structure and a special transfer box (sometimes referred to as magic “boxes”). As a user writes or draws on the specially designed paper with the Anoto Digital Pen, the Anoto Digital Pen creates a digital trace of whatever is done. This information is stored in the pen until the transfer indication box is selected. It is then forwarded from your digital pen directly to your nearby personal computer, or by a Bluetooth™ device—such as a Bluetooth™ enabled mobile phone—to any computer, mobile phone or information bank in the world via the Internet.

One drawback of the Anoto Digital Pens and other types of digital pens that capture handwriting strokes is that the digital pens themselves lack functional buttons or displays to capture additional handwritten gestures such as highlighting, bolding, or color change. For example, when a user handwrites notes and then uses a highlighter to emphasize particular text or patterns, the conventional digital pen device or system such as those described above, only capture the original handwritten information, but are unable to capture the emphasized text or pattern. Moreover, an attempt to go back and, for example, highlight text, using a conventional digital pen device or system may result in canceling or crossing out previously written text.

Some other drawbacks of some digital pens that capture handwriting strokes are that the digital pens do not have added functionalities which can make these pens useful in other ways to a user. For instance, a digital pen with an alarm functionality could be used by a user to remind herself of certain important appointments etc. Such notification to the user could be provided by sound (e.g., a beep, a buzz, etc.), by vibration of the pen, and so on. Another example is a digital pen that can function as a calculator, which could be used to perform quick mathematical calculations. With such a digital pen, a user would be able to dispense with pocket calculators.

Yet another drawback of conventional digital pens is that they do not have a voice-recording functionality. Such a voice-recording functionality would be useful in several situations. For instance, such a feature would be very useful in instances when the user cannot write (e.g., when the user is driving a car), or when the user does not have any special paper available at hand.

Still another drawback of conventional digital pens is that the special paper and the “magic boxes” on such a special paper described above are not reusable, since ink adheres to the paper when the pen is used. In certain situations, it may be desirable to not have the ink adhere to the paper, so that the paper can then be reused. For instance, a user may desire to use over and over again, a “magic box” to transmit written material to a host.

Therefore, there is a need for (1) a digital writing system that captures additional handwritten gestures in addition to handwritten text and patterns; (2) a digital writing system with additional functionalities; (3) a digital writing system with a voice recording and recognition capability; and (4) a digital writing system where, in certain situations, the ink does not adhere to the paper.

### SUMMARY OF THE INVENTION

In accordance with one illustrative embodiment of the present invention, a writing system is configured for capturing image data associated with writing gestures. The writing system also provides additional formatting functionality, for example, bolding, highlighting, underlining, italicizing, and the like. Further, the writing system may include other features that conveniently complement the handwriting capturing functions, such as, for example, a digital camera, a pocket calculator, a user notification feature, alarms, timers, calendar function, biometric sensors, and the like. In one embodiment, the writing system according to the present invention includes a digital pen device with selection mechanisms for a user to select among the different alternative functions provided, for example, highlighting, bolding, underlining, and the like. According to another aspect of the present invention, it is provided a user interface for the management of data files generated by a system according to one embodiment of the invention.

A method according to one embodiment of the present invention includes the capture of information relating to a user's writing. For example, in response to selection signals, a method according to this embodiment includes formatting of captured information. The formatting may include bolding, underlining, highlighting, color change, among other features that may be applied to the captured handwriting. According to one embodiment of the present invention, the formatting features can be selected at different times with respect to the capturing of the handwriting gestures, for example, a bolding selection can be made prior to capturing the handwriting text to be bolded, or alternatively, once some handwriting has been captured, it can be selected for applying highlighting to it.

In addition, according to another aspect of the present invention, several embodiments are presented with additional functions provided. For example, one embodiment of the present invention includes a notification feature that allows a user to preset a trigger or alarm for the notification to take place, such as, for example, a timer or a calendar entry. Several alternatives are also shown for the notification feature including an audible alarm, vibration, visual display or the like. Other convenient functions presented include still or video capturing devices, audio input and output devices, calculator, biometrics, and the like.

The features and advantages described in the specification are not all inclusive and, in particular, many additional features and advantages will be apparent to one of ordinary skill in the art in view of the drawings, specification, and claims. Moreover, it should be noted that the language used in the specification has been principally selected for readability and instructional purposes, and may not have been selected to delineate or circumscribe the inventive subject matter.

### BRIEF DESCRIPTION OF THE DRAWINGS

FIG. 1 is an illustration of a digital pen device according to one embodiment of the present invention.

FIG. 2 is a functional block diagram of a digital pen device according to one embodiment of the present invention.

FIG. 3 illustrates a sample function control subsystem software within a software stack for a digital pen device according to one embodiment of the present invention.

FIG. 4 illustrates a sample process operation of a function control subsystem according to one embodiment of the present invention.

FIGS. 5a, 5b, and 5c show an illustration of one example of an operation according to one embodiment of the present invention.

FIG. 6a is sample screen shot of a user interface according to one embodiment of the present invention.

FIG. 6b is a sample detailed view of a screen shot of a user interface according to one embodiment of the present invention.

### DETAILED DESCRIPTION OF THE INVENTION

The Figures and the following description relate to preferred embodiments of the present invention by way of illustration only. It should be noted that from the following discussion, alternative embodiments of the structures and methods disclosed herein will be readily recognized as viable alternatives that may be employed without departing from the principles of the claimed invention.

One embodiment of the present invention comprises a digital pen device that includes function control selection mechanisms, e.g., buttons, pressure switches, or the like. A user that is writing text, patterns, or other handwritten expression on a writing medium, e.g., paper, may operate the digital pen device. The digital pen device captures the handwritten expression, for example, as images, and stores the handwritten expression as data. If additional expression is added to the handwritten expression, e.g., highlighting a word, the function control buttons are configured to capture this additional expression as data too.

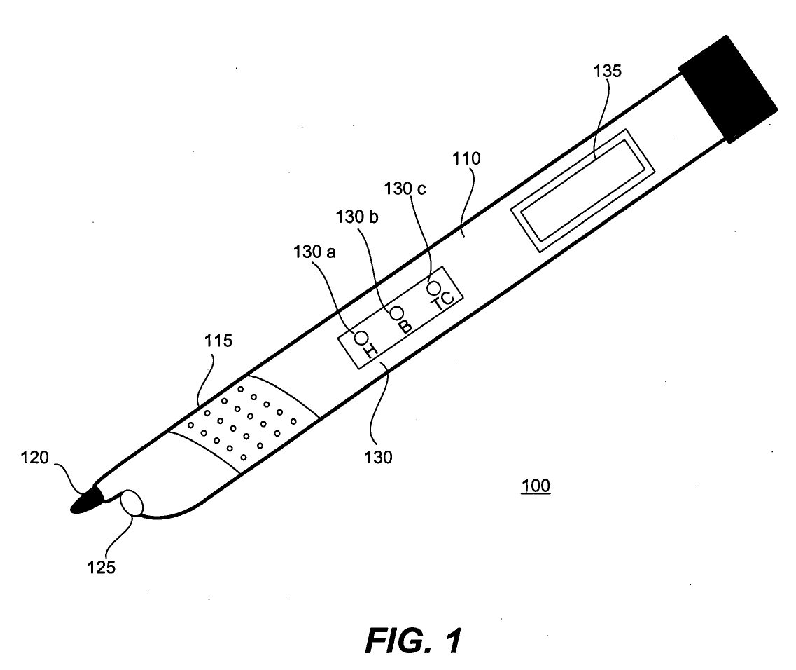

FIG. 1 illustrates a digital pen device 100 in accordance with one embodiment of the present invention. The digital pen device 100 includes a pen barrel 110, an optional grip area 115, a pen (or ink) tip 120, a character recognition lens 125, a function control box 130 and a display area 135. In one embodiment, the ink tip 120 and the character recognition lens 125 are in close proximity to each other. In addition, the function control box 130 may be comprised of one or more mechanical or electrical (e.g., touch sensitive or optical) switches 130a-130c. The function control box 130 may be configured for placement along a side of the pen barrel 110.

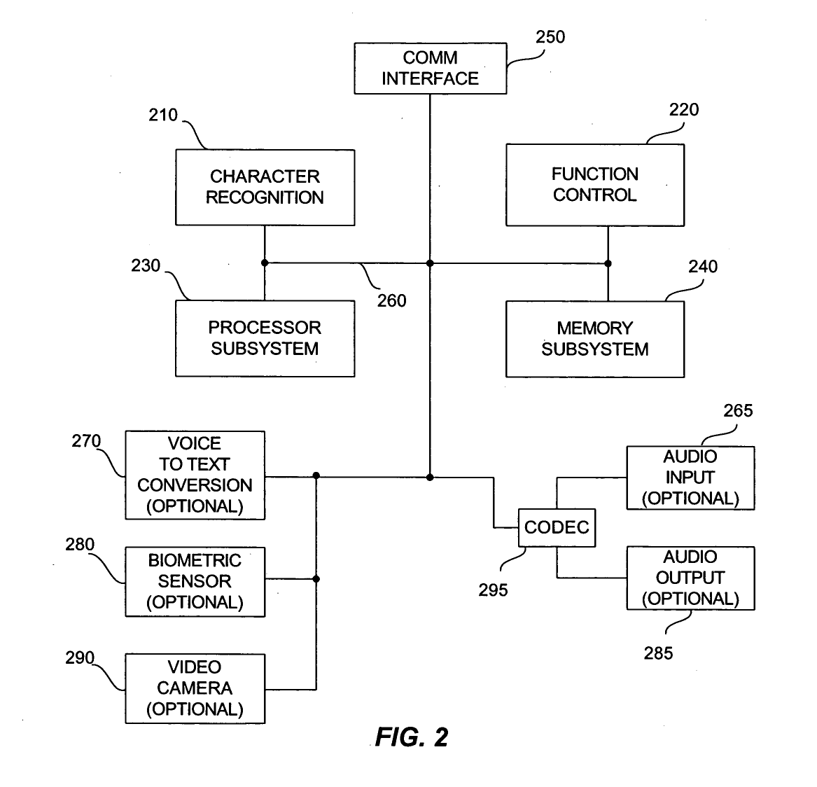

FIG. 2 illustrates a functional block diagram of a digital pen device 100 in accordance with one embodiment of the present invention. The digital pen device 100 includes a character recognition subsystem 210, a function control subsystem 220, a processor (or controller) subsystem 230, and a memory subsystem 240. The character recognition subsystem 210 may include a character recognition lens 125, and may couple with the processor subsystem 230 and the memory subsystem 240. The function control subsystem 220 couples with the processor subsystem 230 and may also couple with the memory subsystem 240 and/or the character recognition subsystem 210.

The character recognition subsystem 210 may be a digital camera or may be an optical character recognition system that includes pattern recognition sensors, e.g., photosensors. In some embodiments, the digital pen 100 includes a separate mini camera 290. In such embodiments, the digital pen 100 can be used as a camera as well as a pen, and can be used capture images or video sequences. In other embodiments, when the character recognition subsystem 210 is a camera, the character recognition subsystem 210 itself may be used to capture images or video sequences.

The character recognition subsystem 210 is configured to capture handwriting gestures, e.g., handwritten text, numbers, symbols, drawings, or other impressions that may appear on a written medium. The function control subsystem 220 may include dedicated (or pre-defined) or configurable (e.g., user definable) functional operations that may, for example, be used in association with one or more application programs. For example, the function control subsystem 220 may be configured to identify an area that a user has highlighted using a highlighter and transmit that information back to an application associated with the character recognition subsystem 210. The processor subsystem 230 provides conventional processor functions, including fetching and executing instructions to carry out functions, for example, functions defined by the character recognition subsystem 210 and the function control subsystem 220. The memory subsystem 240 may include volatile memory (e.g., dynamic and/or static random access memory) and/or non-volatile memory (e.g., flash memory and/or electrically erasable programmable read only memory).

The digital pen device may also include an optional ink cartridge, configured in close proximity to the character recognition device, so that impression written by a user is immediately picked up by the character recognition subsystem 210. In addition, the digital pen device may include a communication interface subsystem 250. The communication interface subsystem 250 may be for wired (tethered) or wireless (non-tethered) communication. The communication interface subsystem 250 may be, for example, a radio frequency transceiver or a universal serial bus interface. Alternatively, the communication interface subsystem 250 may be an Infra Red communication system. The communication interface subsystem 250 couples with, for example, the processor subsystem 230 to transmit information to, for example, a host computer in either real-time or batch mode (e.g., synchronization process such as a docking connection or universal serial bus connection on the pen, or the like). It is also noted that the digital pen device 100 components discussed above may all couple together via a data bus 260 in the digital pen device 100.

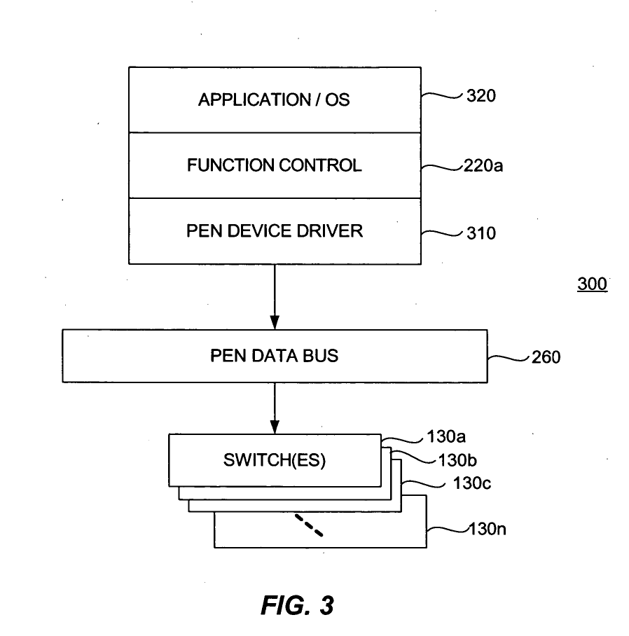

FIG. 3 illustrates one embodiment of the function control subsystem 220 software within a software stack for a digital pen device 100 in accordance with one embodiment of the present invention. The software stack includes a pen device driver 310 and an application 320. The software 220a for the function control subsystem 220 can reside on top of the pen device driver 310, an operating system, or within each individually or in combination. The pen device driver 220 couples with the data bus 260. The pen data bus 260 may include an electrical connection with the function control box 130 (or switches 130a-130c). According to one embodiment of the present invention, a user may configure the selection mechanisms 130a- 130c (130n generally), to correspond to a particular function, e.g., highlighting, bolding, italicizing, underlining, changing font color, or the like. The configuration may be provided on the digital pen 100 itself, or may be done, for example, via a software application on a personal computer that is transmitted to the digital pen 100. Further, different users may configure the selection mechanisms differently and a set of user profiles can be stored on the digital pen 100 and selected prior to operation, for example, using biometrics as discussed below.

During operation, when the user triggers a selection mechanism, e.g., any of 130a-130c alone or in combination, the selection or switching mechanisms 130n send a function selection signal back to the pen data bus 260 to the processor subsystem 230, to the pen device control, and then to the function control subsystem 220. The function control subsystem 220, interprets the function selected and signals the operating system or the application 320 regarding the selected function. The handwriting gestures with which the formatting is associated can be determined in several ways. For example, a user can actuate a selection mechanism 130n to select a formatting function prior to handwriting the gestures to which the formatting applies. Once finished with the handwriting, the user may actuate the same or another selection mechanism to indicate the end of the handwriting gestures to which the formatting applies. In an alternative embodiment, the user may produce the handwriting gestures first, then select a subset of handwriting gestures, and actuate a selection mechanism 130n to apply the formatting to the selected handwriting gestures.

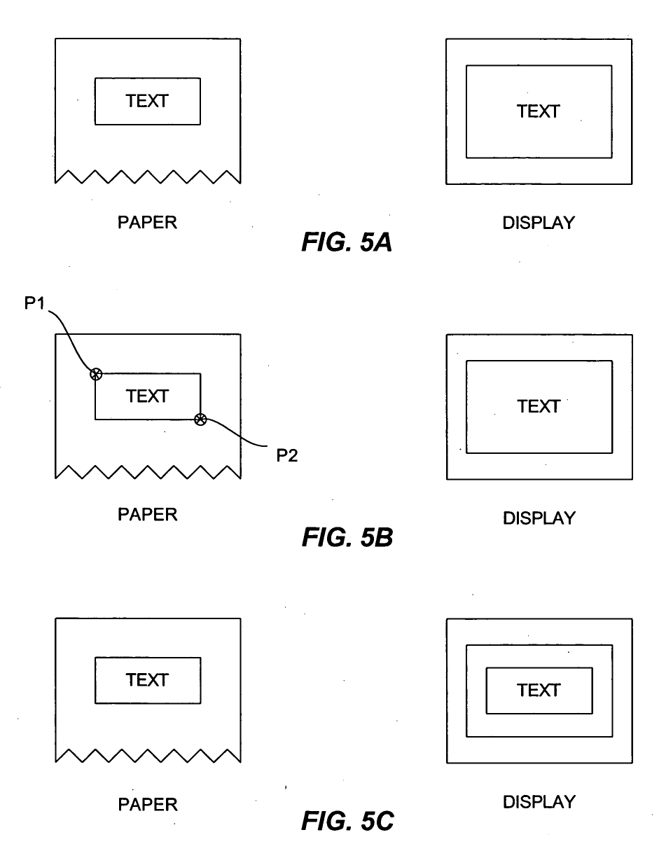

According to the present invention, there are several possible techniques for selecting a subset of handwriting gestures in order to apply the formatting function to it. For example, in one embodiment, patterned paper comprising machine-readable marks or “glyphs” provides a coordinate system that can be interpreted to uniquely identify the location of each individual glyph. This coordinate or location information is typically captured along with the handwriting gestures. Subsequently, a user may indicate the coordinate information (e.g., selecting a set of glyphs) of two opposite corners of a rectangular area on the patterned paper and using the captured coordinate information the processor can determine the subset of handwriting gestures located within the selected rectangular area. For example, FIGS. 5a through 5c illustrate one example of an operation in accordance with one embodiment of the present invention. In this example, existing handwriting gestures are selected by indicating the coordinates of the top left beginning of a handwriting subset and the coordinates of the bottom right end of the subset. Then, the user actuates function control switch 130a, configured for example to “highlight” handwriting gestures. The digital pen 100 then transmits the function (“highlight”) and coordinate information back to the processor subsystem 230, onto the pen device driver 310 and the function control subsystem 220. The function control subsystem 220 would provide information to the application 320 that tells it to highlight the selected area provided by the position coordinates.

According to another embodiment of the present invention, the selection of a subset of captured handwriting gestures for applying a selected formatting function to includes an image processing function. According to this embodiment, handwriting gestures may be captured using an optical imaging system, for example, a photosensor array. The handwriting gestures are captured as bitmaps or similar images created based on the light reflected from a writing surface. Subsequently, a user may actuate a selection mechanism, e.g. a button, and recapture a subset of handwriting gestures to which a formatting function should be applied. Then, a processor can compare previously captured images with the currently captured images to find a match thereby determining the subset of captured handwriting gestures to which the selected formatting function applies. Several other implementations are possible to provide the same functionality. For example, rather than using a selection mechanism 130n, a user may change the tip of the digital pen 100 on a multiple-tip pen embodiment from a ball pen tip, to a highlighter tip and the digital pen 100 would automatically recognize the highlighting function from the use of the highlighter tip and capture the highlighting information accordingly.

In another embodiment, it is possible that a single selection mechanism 130a can be pressed to perform various distinct functions, based on the level or pressure/force applied. For instance, a slight pressure applied to control switch 130a might result in highlighting of the text, some more pressure applied to control switch 130a might result in bolding of the text, while still more pressure applied to control switch 130a might result in changing the color of the text. In one embodiment, the pressure applied by the user can be sensed using a Force Sensitive Resistor (“FSR”) located at the tip of the digital pen 100. In this embodiment, it is not necessary to have a specifically dedicated button on the pen 100 for each desired functionality. In an alternative embodiment, the selection mechanism can be configured as an n-way switch, where n is any integer and corresponds to the number of states (e.g., functions that may be available).

Another example is that in one embodiment, a function control switch 130a is configured for voice recording. In such an embodiment, an apparatus in accordance with the present invention is a dual mode pocket memo recorder that offers both written- and voice-memo download to a host. Such a digital pen 100 can be used, for example, to record to-do list items in the digital pen's memory. Moreover, such a digital pen 100 can be especially useful in situations when a user cannot write, or when the user has no special paper available at hand. For example, a user may be driving a car.

Voice recording by the digital pen 100 can have several other benefits as well. For example, in one embodiment of the present invention, voice recording is linked to written material. For instance, a user could draw on paper using a digital pen 100, and record a verbal description of the drawing. Such a verbal description, along with the linked drawing would provide for a very accurate and clear capture of the thoughts of the user. Yet another example of a benefit of voice recording is that in one embodiment of the present invention, voice recording is used in conjunction with voice recognition. Such a combination can be used, for instance, for email address look-up.

In such an embodiment, the digital pen 100 includes a Coder-Decoder (“CODEC”) 295 to perform functions such as converting a voice analog signal into a digital signal. The CODEC 295 can be implemented in hardware, software, or firmware, or in any combination of these. In one embodiment, compression can be used to store the digital voice data in its stand alone memory (non-volatile) in a more effective way, in order to implement a longer recording time. In one embodiment, the compression algorithm used is compatible with PC standards.

In one embodiment of the present invention, a voice-to-text conversion module 270 is also present in the digital pen 100. The voice-to-text conversion module 270 can be used to convert voice data into text with a specific voice recognition software application, as available today with some voice recorders.

In one embodiment, the digital pen 100 may also have an audio input 265 and an audio output 285. The audio output 285 could be, for example, a speaker or earphone jack. Both the audio input 265 and the audio output 285 may be processed by a CODEC 295. Such a digital pen 100 can be used as a stand alone voice recording and playback system, i.e., without necessarily downloading to a host.

In one embodiment of the present invention, a biometric sensor module 280 is also present in the digital pen 100. For instance this biometric sensor module could be a fingerprint sensor. Such a biometric sensor module 280 can be used for identification of the user of the pen. For some applications, this could be in lieu of a password. If multiple users may be using a digital pen 100, in some embodiments, such biometric sensing could also be used to retrieve each user's preferred settings when that user starts using the pen. In some embodiments, such preferences may also be associated automatically with a user, by identifying the user via biometric sensing. It is noted that the biometric sensor in one embodiment may be functional with the optional grip area 115 or in lieu of the optional grip area 115.

Another example of a functionality that can be available in the digital pen 100 is that of a pocket calculator. Such a digital pen 100 would provide the user with a “pocket calculator” which is easily available, and is small and convenient to carry.

In one embodiment, the numbers and the operators could be captured by handwriting. Thus no keyboard would be needed. In another embodiment, the capture may also be implemented by using special paper with printed numbers and operators. Further, in one embodiment, the result of the calculation could be shown on an on-board display 135, e.g., a liquid crystal display (“LCD”).

Yet another example of a functionality that can be available in the digital pen 100 is that of a user notification function, e.g., an alarm notification or the like, provided in response to a user programmed triggering event. The special paper may include conventional patterned paper, e.g., having glyphs, and the “magic boxes” may be preset patterns corresponding to a function once that pattern image is detected. In addition, in one embodiment, special paper with specific fields (“magic boxes”) can be used to enter an alarm. In one embodiment, different triggering events for the user notifications can be preprogrammed depending on the functionality available in the digital pen. For example, in a digital pen equipped with a digital calendar feature, the triggering event may be an appointment at a certain date and time or a reminder for a special occasion, or the like. Alternatively, in a digital pen that includes a digital watch or a digital timer, the triggering event may be a timer/countdown alarm, or a wake-up alarm, or the like. The user notification can take place in several different ways. For example, some possible user notifications include without limitation, an alarm via the display 135, a buzzer (sound feedback), a vibration of the digital pen 100, or via one or more light emitting diodes (“LEDs”).

In one embodiment with a digital pen having a digital calendar feature, based on the appointments, meetings, reminders, or the like, entered with the digital pen 100, the calendar could be synchronized between the digital pen 100 and a host computer. For example, the synchronizing may be done using the communication module of the digital pen either automatically or at user selected intervals.

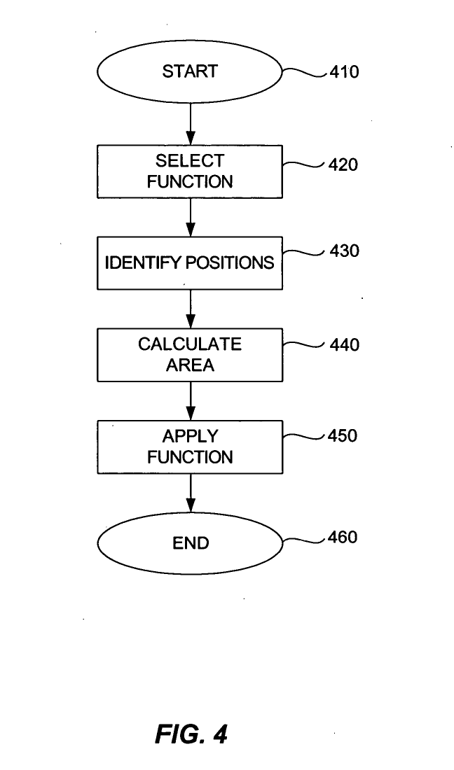

FIG. 4 illustrates a process operation of the function control subsystem 220 in accordance with one embodiment of the present invention. The process starts 410 and a particular function is selected 420 through a selection mechanism, e.g. 1 30a. A position on a writing surface, for example, a piece of paper, is identified 430 on which the functional operation is to occur. In one embodiment, this includes identifying a first location, p1, and a second location, p2 (see, e.g., FIG. 5b) by moving the digital pen over or on those two areas to trigger a selection mechanism (e.g., a switch or a sensor). The function control subsystem 220 then calculates 440 an area, A, using the two position data points. This information may then be passed to, for example, the application 320 to apply the function, e.g., highlighting previously written text as shown in FIGS. 5a through 5c. The process then ends 460 by shutting off or waiting for the next function operation.

A writing system in accordance with one embodiment of the present invention may also be used with a special paper such that ink does not adhere to the paper. Such non-adherence of the ink could result in reusability. In one embodiment, a card which fits into a wallet (e.g., sized like a credit card) could be carried by a user. The user could check of a “magic box” on this card every time he wanted to perform a specific function (e.g., transfer to the host data written on special paper, transfer to the host data written only on a specified page, etc.). In one embodiment, the special paper on such a card could be treated such that ink will not adhere to it.

In one embodiment, the “magic boxes” are predefined and may be Intelligent Character Recognition (“ICR”) fields. Thus, for example, in order to transfer data written on a specified page, the page number could be “written” into an ICR field on the card. In another embodiment, a visual keyboard could be visible on the card, and the appropriate “key” could be tapped on in order to perform a specific function. This could be an alternative to using ICR. Another alternative to using ICR is the use of graffiti, as is well-known in the context of Personal Digital Assistants (“PDAs”). In an alternative embodiment, the “magic box” may be a predetermined pattern (e.g., a character) that is assigned a particular function or operation such that it is performed once the optical system recognizes the predetermined pattern.

Yet another use of the magic boxes is for purposes of “speed-mail.” It is to be noted that in some embodiments, such magic boxes are on the card described above. In other embodiments, the magic boxes are on the paper on which the user is writing. In addition, in some embodiments, ink may adhere to such magic boxes, while in other embodiments, ink may not adhere to such magic boxes. The speed-mail notion is analogous to the speed-dial feature available on most telephone instruments today. Specific e-mail addresses can be pre-programmed into specific numbers (e.g., “1” corresponds to mom's email address, etc.), and then the specific number could be written into a magic box to send the data to the specified email address.

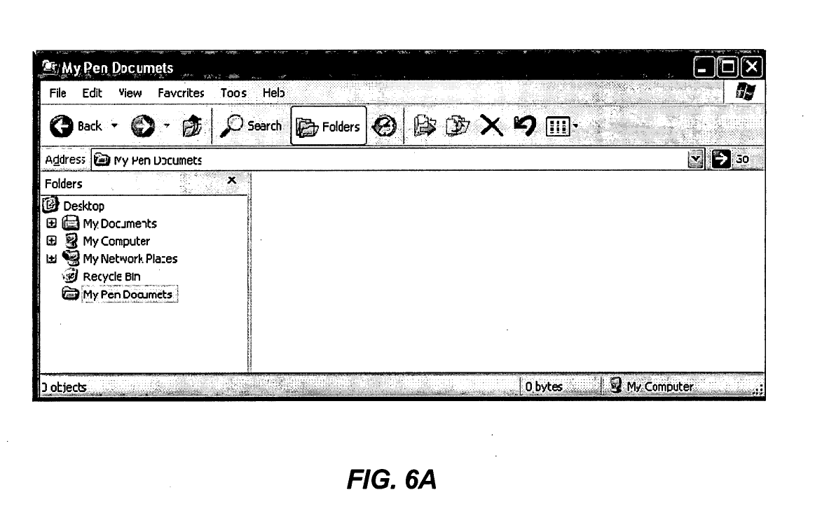

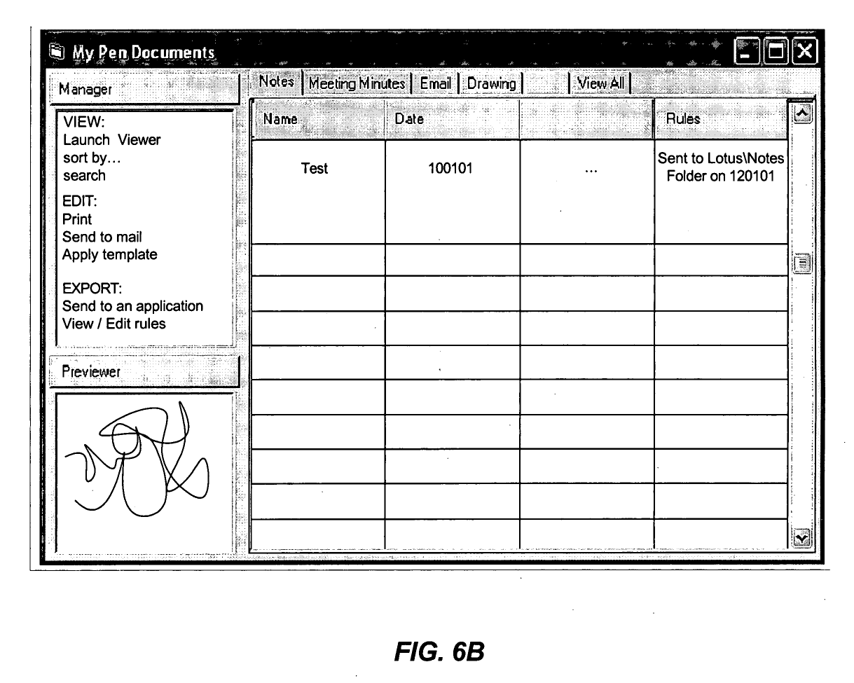

Once documents are created using the digital pen 100, and these are transferred to a host, it should be easy for a user to find them and use them. FIG. 6a is a screenshot of an embodiment of a user interface 600 on a host, which can make it easier for users to find, view, and integrate digital writing documents into other applications.

As can be seen from FIG. 6a, in one embodiment, all documents created with the pen are listed under a folder entitled “My Pen Documents.” It is to be noted that in one embodiment, this destination folder can be renamed or changed by the user as desired. The created documents can be sorted by different criteria (e.g., date, type, etc.). Further, this user interface provides for a preview of the various documents without the need for any third party software. It is also possible to search the documents using a search form.

FIG. 6b provides a more detailed view of the user interface 600. In one embodiment, the user interface 600 allows the user to use the documents directly (e.g., print them, send as an attachment in an email, send directly in an email, etc.). Moreover, when the documents are transferred to the host, some tags may be inserted into them (e.g., date, time, author's name, sub-title, keyword etc.). In one embodiment, the insertion of such tags may be automatic. In another embodiment, the insertion of such tags may be manual. In yet another embodiment, the insertion of such tags may be a combination of automatic and manual.

In one embodiment, the user interface 600 may include a list of templates for each type of document. (The various “types” of documents can include emails, faxes, letters, meeting minutes, notes, to-do lists, drawings, calendar entries, and so on). For instance, if the document is a fax document, the user can automatically insert the document into a fax template. The document can them be faxed using third party software. In one embodiment, the user interface 600 permits the user to seamlessly integrate with third party software.

In one embodiment, the user may be able to assign certain rules to a specific document, or to a type of document. For instance, if a document is an email, a user can assign rules such as which application to use for the email (e.g., Microsoft Outlook™, Lotus Notes™, etc.), the way the document will appear (e.g., in draft form, etc.), and so on. Further, such rules can be assigned to the specific email in question, or to all emails created with the digital pen 100. Moreover, a rule may be set as a permanent rule or as a temporary rule.

In one embodiment of the present invention, a user can set up such rules by using a “Rule-setup Wizard” which assists the user in defining and assigning rules.

The digital pen 100 may also be configured to provide bi-directional (or alternatively unidirectional) communication with another device, e.g., a host computer, through its communication subsystem 250. For example, in one embodiment when the digital pen 100 is connected with a host computer, the host computer can be configured to retrieve digital pen status information. Alternatively, the digital pen 100 can be configured to transmit pen status information to the host computer. In either case, the host computer can display the pen status information. Pen status information may include, for example, battery status, available memory, used memory, pen serial number, pen identifier, user settings (e.g., configuration of selection mechanism), and the like. Moreover, pen information may also include commands transmitted from the host computer to the digital pen 100, for example, setting an indicator (e.g., vibrator, LED) ON/OFF or setting power-off delays, or synchronizing a calendar, or the like.

While particular embodiments and applications of the present invention have been illustrated and described herein, it is to be understood that the invention is not limited to the precise construction and components disclosed herein and that various modifications, changes, and variations may be made in the arrangement, operation, and details of the methods and apparatuses of the present invention without departing from the spirit and scope of the invention as it is defined in the appended claims.

1. A digital writing system for entering handwriting data in a host system, the digital writing system comprising:
a digital pen device for capturing handwriting gestures, the digital pen device including a function selection mechanism to select a formatting function for association with the handwriting gestures; and
a communication system for coupling the digital pen device to the host system to communicate the captured handwriting gestures, including the selected formatting function, from the digital pen device to the host system.

2. The digital writing system of claim 1, wherein the formatting function further comprises one from a group consisting of bolding, italicizing, highlighting, underlining, and changing font colors.

3. The digital writing system of claim 2, further comprising a function module comprising one from the group consisting of a user notification module, a calculator module, a digital camera module, an audio input/output module, a biometric sensor module, a calendar module, and a digital timer module.

4. The digital writing system of claim 1, wherein the communication system comprises a wireless transmitter configured to transmit data associated with the captured handwriting gestures between the digital pen device and the host system.

5. The digital writing system of claim 1, further comprising an application software system for execution in the host system to communicatively couple the communication system to receive handwriting data from the digital pen device and to enable processing of the captured handwriting gesture on the host system.

6. The digital writing system of claim 1, further configured for use with a writing surface and ink, the ink housed within the digital pen device for writing on the writing surface and wherein the ink does not permanently adhere to the writing surface.

7. A digital pen device for capturing handwriting gestures and converting them into digital data for transmission to a computer system, the digital pen device comprising:
a pen barrel;
a character recognition module housed within the pen barrel for capturing the handwriting gestures;
a processor housed within the pen barrel and coupled to the character recognition module for converting the captured handwriting gestures into a first computer readable data;
a function selection module at least partially housed within the pen barrel and coupled to the processor, the function selection module including function selection mechanisms for selecting a formatting function to associate with the handwriting gestures, the processor furthered configured to associate the formatting function with the handwriting gestures as formatting information and to convert the formatting information into a second computer readable data; and
a communication module at least partially housed within the pen barrel and coupled to the processor for transmitting the first and the second computer readable data to the computer system.

8. The digital pen device of claim 7, further comprising a feature module at least partially housed within the pen barrel for providing a second feature wherein the feature module comprises one from the group consisting of a user notification module, a digital camera, a voice recorder, a calculator, a voice recognition module, an audio file player, a calendar, a timer, and a biometric sensor.

9. The digital pen device of claim 8, wherein the user notification module is configured to provide at least one from the group consisting of an audible alarm, a display message, a vibration, and a visible alarm.

10. The digital pen device of claim 7, wherein the character recognition module comprises a character recognition lens and a photosensor array, the character recognition lens to project light reflected from the handwriting gestures and a writing surface to the photosensor array.

11. The digital pen device of claim 7, wherein the selection mechanisms comprise at least one from the group consisting of a button, a force sensitive resistor, and a switch.

12. The digital pen device of claim 7, wherein the communication module comprises a wireless transmission system.

13. The digital pen device of claim 13, wherein the wireless transmission system communicates using one of the group consisting of radio frequency signals and infrared signals.

14. The digital pen device of claim 7, wherein the communication module comprises a Universal Serial Bus (USB) link.

15. A method for digitally capturing handwriting gestures with a digital writing system comprising a digital pen device, the method comprising:
capturing handwriting gestures produced by a user on a writing surface using the digital pen device;
converting the captured handwriting gestures into computer readable image data;
receiving a formatting function selection signal from a selection mechanism located on the digital pen device indicating a format for application to at least a subset of the handwriting gestures;
in response to receiving the formatting function selection signal generating formatting data to apply to the computer readable image data corresponding to the subset of the handwriting gestures; and
transmitting the computer readable image data and the formatting data to a host system.

16. The method of claim 15, further including storing the computer readable image data and the formatting data in a memory device prior to transmitting to the host system.

17. The method of claim 15, wherein the transmitting takes place substantially concurrently with the converting the captured handwriting gestures into computer readable image data.

18. The method of claim 15, wherein the transmitting comprises transmission of the computer readable image data and the formatting data through one from a group consisting of a Universal Serial Bus, a radio frequency transmitter, and an Infrared port.

19. The method of claim 15, further comprising providing a user notification in response to an occurrence of a triggering event, the user notification comprising one from the group consisting of an audible notification, a visible notification, and a vibrating notification.

20. The method of claim 19, wherein the triggering event is one from the group consisting of an appointment, a calendar reminder, a meeting reminder, a clock alarm, and a timer count.
